(19) United States
(12) Patent Application Publication
(10) Pub. No.: US 2002/0122605 A1
(43) Pub. Date: Sep. 5, 2002

(54) Visual terminal apparatus having a pseudo background function and method of obtaining the same

(75) Inventor: Sang-Woon Chang, Songnam-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD, KYUNGKI-DO (KR)

(21) Appl. No.: 10/038,011

(22) Filed: Jan. 3, 2002

(30) Foreign Application Priority Data
Jan. 11, 2001 (KR) 2001-1619

(51) Int. Cl. G06K 9/36

(52) U.S. Cl. 382/284

(57) ABSTRACT

A visual terminal apparatus for providing a visual telephone service includes a camera unit for photographing a user image; an image processing unit connected to the camera unit for extracting only the user's face from the user image outputted from the camera unit and synthesizing the extracted user's face with a pseudo background; and a display unit for displaying the image outputted from the image processing unit.

### PRIORITY

This application claims priority to an application entitled “IMAGE TERMINAL APPARATUS HAVING A PSEUDO BACKGROUND FUNCTION AND METHOD OF OBTAINING THE SAME” applied with the Korean Industrial Property Office on Jan. 11, 2001 and assigned Ser. No. 2001-1619, the contents of which are hereby incorporated by reference.

### BACKGROUND OF THE INVENTION

1. Field of the Invention

The present invention relates to a visual terminal apparatus, and more particularly, to an image processing apparatus and method thereof in a visual terminal apparatus.

2. Description of the Related Art

Recently, a visual mobile telephone service developed as IMT2000 (International Mobile Telecommunications-2000) has been commercialized. IMT2000 is a global multimedia communication service which can provide high quality multimedia communication services such as voice, internet, image, etc., by using advanced voice compression and restoring techniques, and by which every subscriber can send and receive desired audio/video data via one terminal from any place in the world.

A visual mobile telephone employing the service described above allows users to communicate with each other while seeing their counterparts. The visual terminal apparatus typically comprises photographing means such as a camera for photographing the user and a display unit for displaying images sent from the counterpart side to realize a visual telephone function. The images sent may also include background objects at the location of the user.

However, the visual mobile telephone may undesirably expose the location of the user based on the background objects, even if the user does not want to expose his/her location. For example, the visual mobile telephone may problematically transmit a background image to the counterpart, such as if the user is in a bathroom or a bed room which he/she does not want to show to others. Also, the visual mobile telephone can be maliciously used for monitoring the user.

Therefore, it is desired to show a background image which is different from the real background image to the counterpart if it is undesirable for the user to expose the real background image during a conversation through the visual mobile telephone.

### SUMMARY OF THE INVENTION

The present invention is proposed to solve the foregoing problem of the visual mobile terminal apparatus of the related art, and it is therefore an object of the invention to provide a method and apparatus for allowing a user of a visual terminal apparatus to transmit a pseudo background image to a counterpart when he/she does not want to expose their present location to the counterpart.

According to an embodiment of the invention to obtain the foregoing object, there is provided a visual terminal apparatus for providing a visual telephone service, comprising: a camera unit for photographing a user image; an image processing unit connected to the camera unit for extracting only a portion of the user's image, such as the user's face, from the user image outputted from the camera unit and synthesizing the extracted user's face with a pseudo background; and a display unit for displaying the image outputted from the image processing unit.

### BRIEF DESCRIPTION OF THE DRAWINGS

FIG. 1 shows a block diagram of a visual terminal apparatus according to an embodiment of the invention;

FIG. 2 shows an operational control flow of a visual terminal apparatus according to a first preferred embodiment of the invention; and

FIG. 3 shows an operational control flow of a visual terminal apparatus according to a second preferred embodiment of the invention.

### DETAILED DESCRIPTION OF THE PREFERRED EMBODIMENTS

Hereinafter, preferred embodiments of the present invention will be described in detail with reference to the appended drawings. While a number of specific elements, such as a detailed configuration or a process flow of a mobile terminal apparatus, are described and shown in the following specification and appended drawings, it should be apparent to those skilled in the art that these specific elements are provided only for the overall understanding of the invention and the invention can be performed without these specific elements. Also, a detailed description will be omitted about known functions and configurations that may unnecessarily obscure the inventive aspects of the invention. Further, in the following description of reference numerals, it should be understood that like components are referenced to by like numerals as far as possible even if shown in different drawings.

The present invention provides a method and apparatus for transmitting an image of a user synthesized with a pseudo background image so that the real background of the user is not exposed in a visual conversation through a visual terminal apparatus. For that purpose, the visual terminal apparatus of the present invention comprises an image processing unit to extract only a user's face from a user image acquired by a camera unit and synthesize the acquired user's face with a random background.

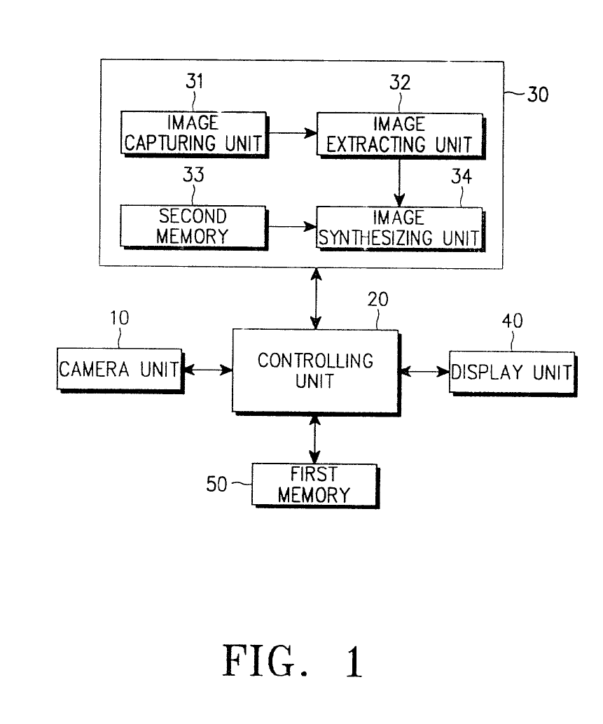

FIG. 1 shows a block diagram of a visual terminal apparatus according to an embodiment of the invention for illustrating those components related to the invention only. In accordance with the invention, examples of the visual terminal apparatus can include a visual telephone, a mobile/portable telephone, a PDA (Personal Data Assistant), and a computer capable of visual communication.

A controlling unit 20 of the visual terminal apparatus according to the invention controls the overall operation of the visual terminal apparatus, and also controls each component of the visual terminal apparatus which is related to user background processing.

A camera unit 10 takes an image of the visual terminal apparatus user and the background. The camera unit 10 comprises a lens to photograph an image viewed through the lens. A display unit 40 can be an LCD (Liquid Crystal Display) and displays a number of data, messages and images under the control of the controlling unit 20. First memory 50 includes a program memory for storing program data and key input data necessary for the operational control of the visual terminal apparatus and a data memory for storing data created under the control of the controlling unit 20 or by a user side operation.

An image processing unit 30 of the visual terminal apparatus extracts only the user's image from the image outputted from the camera unit 10, and synthesizes the user's image with one randomly selected background image, stored in a memory, to be displayed on a display unit 40. More particularly, the image processing unit 30 includes an image capturing unit 31, an image extracting unit 32, a second memory 33 and an image synthesizing unit 34. The image capturing unit 31 captures the image from the camera unit 10, namely, the user's face and background as image files. The image capturing unit 31 outputs the captured image to the image extracting unit 32. The image extracting unit 32 recognizes only a portion of the output image corresponding to the user's face and outputs the portion recognized as a face to the image synthesizing unit 34. Here, a face recognizing method can be selected from a number of previously proposed methods. For example, a method can be used in which an image p1 captured by the image capturing unit at time t1 is compared with another image p2 captured at time t2 to obtain the rate of instantaneous change about mutually corresponding points, and a random point is selected which can be a point of the face, so that a line is formed by connecting the outermost points from those having the same change rate as the selected point and then recognized as the face. Here, the rate of instantaneous change can be expressed by a differential value according to equation 1:

$${f}^{′} ( t ) = {lim}_{Δ t - .0} \frac{f ( t + Δ t ) - f ( t )}{Δ t} , \qquad equation 1$$

where f′ (t) means the differential value at t1, f(t+Δt) is p2, f(t) is p1, Δt is t2−t1.

The image extracting unit 32 detects portions which do not correspond to the user's face in the image outputted from the image capturing unit 31, and reports the detected portions to the controlling unit. Then, the controlling unit controls the direction of the camera unit 10 so that the portions corresponding to the user's face can be captured as an image.

The image synthesizing unit 34 synthesizes the user's image from the image extracting unit 32 with a background image from the second memory 33. The second memory 33 stores a plurality of background images. The background images can be downloaded from the internet or a computer by the user. Alternatively, the user can store an image inputted through the camera unit 10 of the visual terminal apparatus in the second memory as the background image. It should be understood by those skilled in the art that the first memory 50 and the second memory 33 can be integrated. The image synthesizing unit 34 outputs only the background image from the second memory to the display unit 40 if there is no output from the image extracting unit 32.

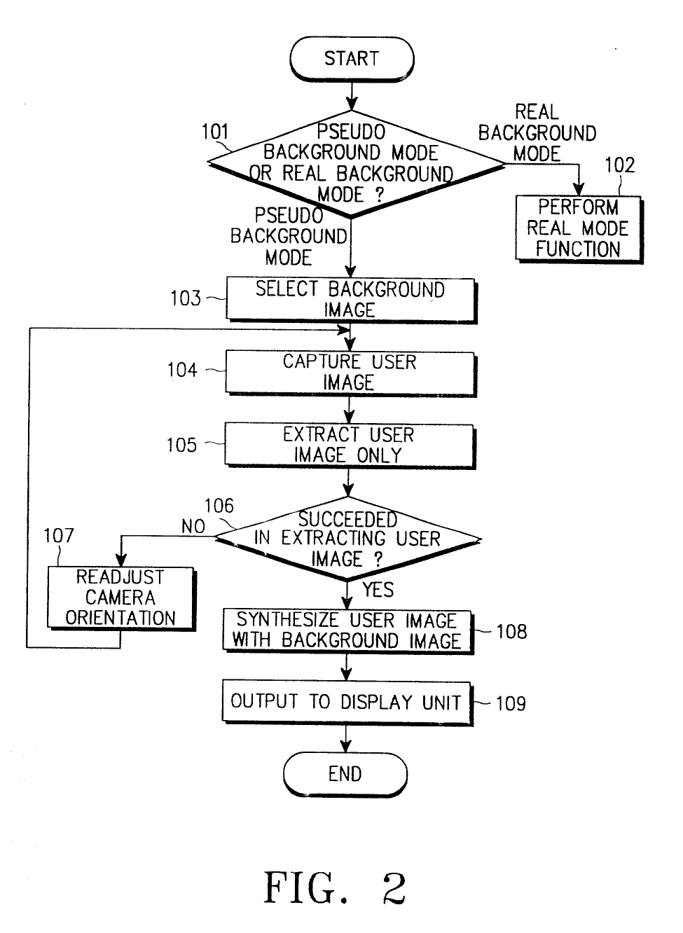

FIG. 2 shows an operational control flow of a visual terminal apparatus according to a first preferred embodiment of the invention. Hereinafter, the first preferred embodiment of the invention will be described in detail in reference to FIG. 1 and FIG. 2.

First, the user of the visual terminal apparatus selects the background mode of the image to be transmitted to the conversation counterpart as a pseudo background mode or a real background mode. Accordingly in step 101, the visual terminal apparatus decides to enter the pseudo background mode or the real background mode. If the user selects the pseudo background mode, the visual terminal apparatus proceeds to step 103, and if the user selects the real background mode, the visual terminal apparatus proceeds to step 102 to perform the functions of a typical visual terminal apparatus. The visual terminal apparatus selects one of the background images in step 103. Alternatively, the user of the visual terminal apparatus can select one of the background images. The background images are stored in the second memory 33 of the image processing unit 30 in advance. The background images can be provided by a communication provider or can be stored by the user after photographing suitable background images with the camera unit 10 in advance. In the case of selecting the background image, the user can select the background image in a standby mode before the conversation or at the time of an incoming call.

After the selection of the background image, the visual terminal apparatus captures the user image including the user and the background through the camera unit 10 in step 104. In step 105, the visual terminal apparatus extracts only the user's image from the captured image via the image capturing unit 31. With the image extracting unit 32, only the portions corresponding to the user's face are recognized from the image captured from the image capturing unit 31 by using an outline recognizing algorithm which is well known in the art. The image extracting unit 32 transmits only the portion recognized as the user's face to the image synthesizing unit 34. In this application, the user's image practically means not only the face of the user but also the body parts.

In step 106, the visual terminal apparatus judges if the image extracting unit 32 succeeded in extracting the user's face. If it failed to extract the user's face, the visual terminal apparatus proceeds to step 107. In step 107, the visual terminal apparatus readjusts the orientation of the camera unit 10 to photograph the user's face again, and then proceeds to step 104 again. If the image extracting unit 32 has succeeded in extracting the user's face, the visual terminal apparatus synthesizes the user's face in the output image from the image capturing unit 31 with the background image stored in the second memory 33 in step 108, and displays the synthesized image via the display unit 40 in step 109. In step 108, the visual terminal apparatus will provide only the background image from the second memory 33 to the display unit 40 if the user's face is not outputted from the image extracting unit 32.

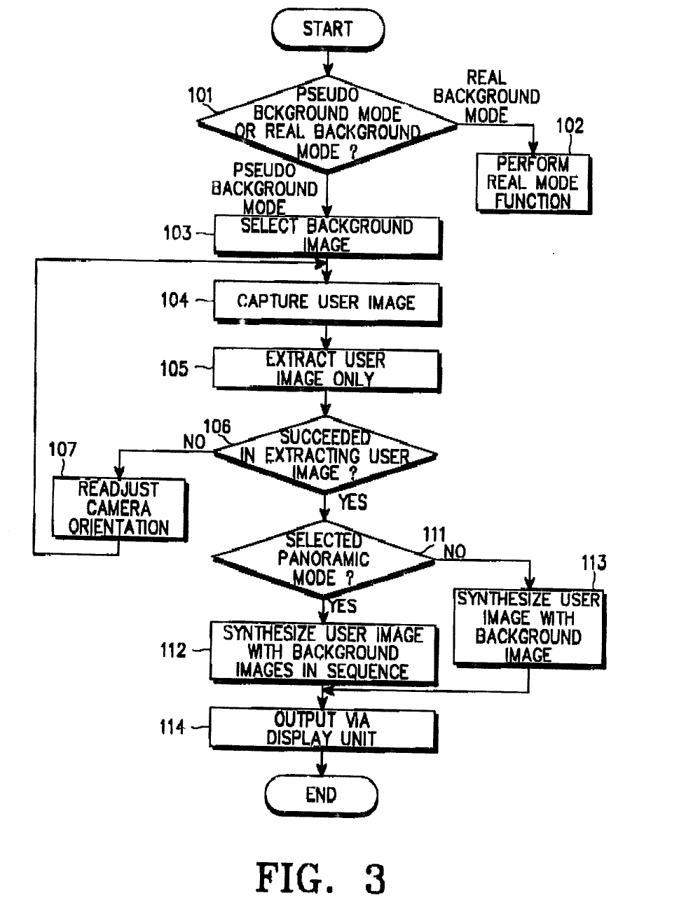

FIG. 3 shows an operational control flow of a visual terminal apparatus according to a second preferred embodiment of the invention. In the operational control flow of the visual terminal apparatus according to the second embodiment of the invention, step 101 to step 107 are the same as those of the visual terminal apparatus according to the first embodiment of the invention, and thus the explanation thereof will be omitted.

In the second preferred embodiment of the invention, the visual terminal apparatus judges if the image extracting unit 32 has succeeded in extracting the user's face in step 106, and proceeds to step 111 if successful. The visual terminal apparatus stands by for a panoramic mode selection in step 111. If the user selects the panoramic mode as the background image, the visual terminal apparatus proceeds to step 112, and proceeds to step 113 if not. In step 113, the visual terminal apparatus synthesizes the user's face in the output image from the image capturing unit 31 with the background image stored in the second memory 33, and displays the synthesized image via the display unit 40 in step 114. Alternatively in step 113, the visual terminal apparatus will provide only the background image from the second memory 33 if the user's face is not outputted from the image extracting unit 32 as in the first preferred embodiment of the invention.

If the user selects the panoramic mode as the background image, the visual terminal apparatus sequentially synthesizes the user's face with a plurality of background images from the second memory in step 112, and outputs the synthesized image via the display unit 40. According to the second preferred embodiment of the invention, the panoramic mode functions to have an effect as if a person looks around at a defined space, and can be performed by storing the pseudo background images in the second memory 33 in a panoramic manner and outputting the stored images in sequence. For example, a 360 degree panoramic background can be generated via VR (Virtual Reality) photography by the camera unit 10 of the visual terminal apparatus. Also, the user can create the 360 degree panoramic background, which can be displayed while being rotated as much as desired, from a plurality of still pictures by using a personal computer and a known software program. In the case of synthesizing the user's face with the background image in the panoramic mode, the visual terminal apparatus so adjusts that the user's face fades out to the right or left side from a screen leaving only the background to proceed in the right or left direction in the screen and then gradually fades the user's face in from the right or left side of the screen of the display unit. The visual terminal apparatus outputs the panoramically synthesized image via the display unit 40.

In this manner, the visual terminal apparatus and method of realizing the same according to the invention is adapted to extract only the user's image from the input image into the camera unit and store the pseudo background in the random memory so that the user's image and the pseudo background can be synthesized.

Also, it should be understood that the method of transmitting the pseudo background of the visual terminal apparatus according to the invention can be easily applied when the visual communication is performed by other mobile communication terminals in addition to the mobile telephone, such as a PDA, or a computer comprising a fixed communication terminal or a data communication connecting unit.

According to the invention constructed as described hereinbefore, the pseudo background image can be transmitted to the counterpart when the user of the visual terminal apparatus does not want to expose his/her present location.

While the present invention has been described in connection with specific embodiments accompanied by the attached drawings, it will be apparent to those skilled in this art that various changes and modifications may be made thereto without departing from the scope of the present invention.

What is claimed is:

1. A visual terminal apparatus for providing a visual communication service, comprising:
a camera unit for photographing a user image;
an image processing unit connected to said camera unit for extracting a portion of user's image outputted from said camera unit and synthesizing the extracted portion of the user's image with a pseudo background; and
a display unit for displaying the synthesized image outputted from said image processing unit.

2. A visual terminal apparatus according to claim 1, wherein said image processing unit includes:
an image capturing unit for capturing the user and background from the camera unit as an image file;
an image extracting unit connected to said image capturing unit for extracting the portion of the user's image outputted from said image capturing unit;
a memory for storing a plurality of backgrounds; and
an image synthesizing unit connected to said image extracting unit and said memory for synthesizing the portion of the user's image from said image extracting unit with at least one of the backgrounds from the memory.

3. A visual terminal apparatus according to claim 2, wherein said image synthesizing unit outputs only the background from said memory if the user's image is not outputted from said image extracting unit.

4. A visual terminal apparatus according to claim 1, wherein said visual terminal apparatus is one selected from a group including a visual telephone, a mobile telephone, a PDA and a computer capable of visual communication.

5. A visual terminal apparatus according to claim 1, wherein the portion of the user's image comprises the user's face.

6. A method for transmitting a pseudo background image in a visual terminal apparatus which comprises a camera unit for photographing a user image to provide a visual telephone service, a memory for storing a plurality of background images and a display unit for displaying images, said method comprises the following steps of:
capturing the user and background image photographed by the camera unit as an image file;
extracting a user's image from the captured image; and
synthesizing the extracted user's image with at least one of the background images from the memory to output a synthesized image to the display unit.

7. A method for transmitting a pseudo background image in a visual terminal apparatus according to claim 6, further comprising the step of outputting the background image from the memory to the display unit if the user's image has not been extracted from the captured image.

8. A method for transmitting a pseudo background image in a visual terminal apparatus which comprises a camera unit for photographing a user image to provide a visual telephone service, a memory for storing a plurality of background images and a display unit for displaying images, said method comprises the steps of:
capturing the user and background image photographed by the camera unit as an image file;
extracting a user's image from the captured image; and
synthesizing the extracted user's image with the plurality of background images from the memory to output a synthesized image to the display unit in a panoramic manner.

9. A method for transmitting a pseudo background image in a visual terminal apparatus according to claim 8, further comprising the step of outputting the background image from the memory to the display unit if the user's image has not been extracted from the captured image.
